(19) United States
(12) Patent Application Publication
(10) Pub. No.: US 2025/0067367 A1
(43) Pub. Date: Feb. 27, 2025

(54) Retainer Fingers for Retaining Tubes of Different Sizes

(71) Applicant: Illinois Tool Works Inc., Glenview, IL (US)

(72) Inventor: Paul D. Barkauski, New Lenox, IL (US)

(21) Appl. No.: 18/808,911

(22) Filed: Aug. 19, 2024

Related U.S. Application Data
(60) Provisional application No. 63/534,686, filed on Aug. 25, 2023.

(51) Int. Cl. F16L 3/10; F16L 3/12

(52) U.S. Cl. CPC F16L 3/10; F16L 3/12

(57) ABSTRACT

Described is a tube retainer for retaining tubes of various diameters. The tube retainer includes a body to receive a tube via a tube pocket, a lid coupled to the body via a hinge, and a plurality of flexible fingers extending into the tube pocket and configured to flex to accommodate a diameter of the tube. The plurality of flexible fingers comprises a first set of flexible fingers resiliently coupled to the lid and a second set of flexible fingers resiliently coupled to the body. The tube retainer may secure the tube relative to a component via a fastener defining a central longitudinal axis, The fastener engaging the component via an opening.

### RELATED APPLICATION

The present application claims priority to U.S. Provisional Patent Application No. 63/534,686, filed Aug. 25, 2023, and entitled “Retainer Fingers For Retaining Tubes Of Different Sizes,” which is hereby incorporated by reference in its entirety.

### BACKGROUND

Vehicular (e.g., automotive) components require attachment and fastening techniques that are simple to manufacture and assemble. In many instances, objects need to be securely fastened to the vehicle to prevent movement or shifting during operation, which can cause damage, kinking, or rattling. For example, tubes, hoses, wires, and other conduits are often secured to vehicle components using tube retainers.

Fastening techniques for attaching tube retainers must be reliable and efficient. In some cases, the tube retainer can be secured to the vehicle through a panel opening or by engaging a stud. Therefore, the tube retainer may include either a stud fastener feature to engage a stud associated with a vehicular component or a panel fastener feature to engage a panel opening associated with the vehicular component.

Traditional tube retention systems often fail to accommodate a wide range of tube sizes without compromising the retention force or resistance to sliding. Existing flexible retaining systems provide poor retention, which results in insufficient resistance to tube slide forces. This often requires end-users to stock different types and sizes of fasteners in their inventory to address various tube sizes.

The present disclosure addresses these challenges by introducing a multi-size tube flexible finger retainer that can firmly secure tubes of various diameters while maintaining high resistance to sliding forces. Therefore, despite advancements to date, it would be highly desirable to have a fastener that is configured to engage various tube sizes.

### SUMMARY

The present disclosure relates generally to fasteners and retainers, substantially as illustrated by and described in connection with at least one of the figures, as set forth more completely in the claims. In one example, disclosed is a multi-size tube flexible finger retainer designed to hold and retain multiple tube diameters.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIGS. 1a and 1b illustrate a fastening system configured to secure one or more tubes relative to a component having an opening formed therein via a tube retainer in accordance with an aspect of this disclosure.

FIGS. 1c and 1d illustrate first and second isometric views of the tube retainer of FIGS. 1a and 1b securing, respectively, a first tube having a first diameter and a second tube having a second diameter.

FIG. 2a illustrates an isometric view of the retainer portion of the tube retainer of FIGS. 1a through 1d.

FIG. 2a illustrates an isometric view of the retainer portion of the tube retainer of FIGS. 1a through 1d in the closed position.

FIGS. 2b and 2c illustrate elevation views of, respectively, a first side and a second of the retainer portion of FIG. 2a.

FIGS. 2d and 2e illustrate, respectively, top and bottom plan views of the retainer portion of FIG. 2a.

FIGS. 2f and 2g illustrate elevation views of, respectively, the front and rear sides of the retainer portion of FIG. 2a.

FIG. 2h illustrates an elevation view of a front side of the retainer portion of FIG. 2a in the open position.

FIG. 2i illustrates a tube retainer in accordance with an aspect of this disclosure configured to secure multiple tubes.

FIG. 3a illustrates an isometric view of the retainer portion for the tube retainer of FIGS. 1a through 1d in the closed position in accordance with another example.

FIGS. 3b and 3c illustrate elevation views of, respectively, a first side and a second of the retainer portion of FIG. 3a.

FIGS. 3d and 3e illustrate, respectively, top and bottom plan views of the retainer portion of FIG. 3a.

FIGS. 3f and 3g illustrate elevation views of, respectively, the front and rear sides of the retainer portion of FIG. 3a.

FIG. 3h illustrates an elevation view of a front side of the retainer portion of FIG. 3a in the open position.

FIGS. 4a through 4f illustrate additional fastener styles suitable for coupling the carrier portion with the component in accordance with other aspects of this disclosure.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

A tube retainer can be used to couple an object to a component, such as a tube to a vehicular component. Typical tube retention features hold the tube firmly, accommodating a small range of tube diameters without negatively affecting retention and sliding force. In contrast, flexible retaining systems often fail to hold the tube securely, resulting in poor retention and sliding force. The disclosed retainer, however, allows for a wide range of tube sizes. The cam interference can be precisely tuned to provide consistent force across a large range of tube diameters, ensuring effective retention and reliable sliding force.

The disclosed tube retainer is configured to retain multiple tube diameters and incorporates several novel features to ensure versatility and secure attachment. The tube retainer is specifically engineered to accommodate and hold tubes of varying diameters, making it highly adaptable. The tube retainer can be produced via injection molding or 3D printing applications, ensuring ease of manufacturing. The tube retainer is flexible, allowing it to securely retain multiple diameters. The retainer comprises one or more sets of retaining features, for example, one set on the body and another on the cover. Additionally, a hinge can be created between the body and cover (e.g., lid) to enhance flexibility during tube assembly. The flexible fingers are configured to interfere with each other or with the sides of the lid and body, or both, creating a cam-like force on the tube retainer. This interference generates a force on the tube, increasing the sliding force and ensuring a secure hold.

In one example, a tube retainer is designed to accommodate and secure tubes of various diameters. The retainer consists of a body configured to receive a tube through a tube pocket, and a lid that is coupled to the body via a hinge. A key feature of this retainer is a plurality of flexible fingers that extend into the tube pocket and are engineered to flex according to the tube's diameter. These flexible fingers are divided into two sets: the first set is resiliently coupled to the lid, while the second set is resiliently coupled to the body.

The flexible fingers extend inward toward a central longitudinal axis of the tube retainer. Specifically, the first set of flexible fingers extends from the lid toward the base, and the second set extends from the base toward the lid. These sets of flexible fingers are arranged to form an angle relative to one another, which can vary between 70 and 110 degrees. Each flexible finger is equipped with a first and a second engagement feature, spaced apart to enhance their ability to securely grip tubes of different diameters.

To ensure the lid remains securely attached to the body, the tube retainer includes a snap mechanism located at the end of the lid opposite the hinge. This snap is designed to engage with a corresponding feature on the body, and the snap may include a button to facilitate disengagement when necessary. The entire structure of the retainer-including the body, lid, hinge, and flexible fingers—can be fabricated as a unitary structure to enhance durability and simplify manufacturing.

The tube retainer is further configured to secure the tube relative to a component via a fastener, which defines a central longitudinal axis. This fastener is designed to engage with a corresponding opening in the component, ensuring that the tube remains securely in place. The flexible fingers on both the lid and the body are designed to flex towards and away from each other, accommodating tubes of varying sizes while maintaining a firm grip.

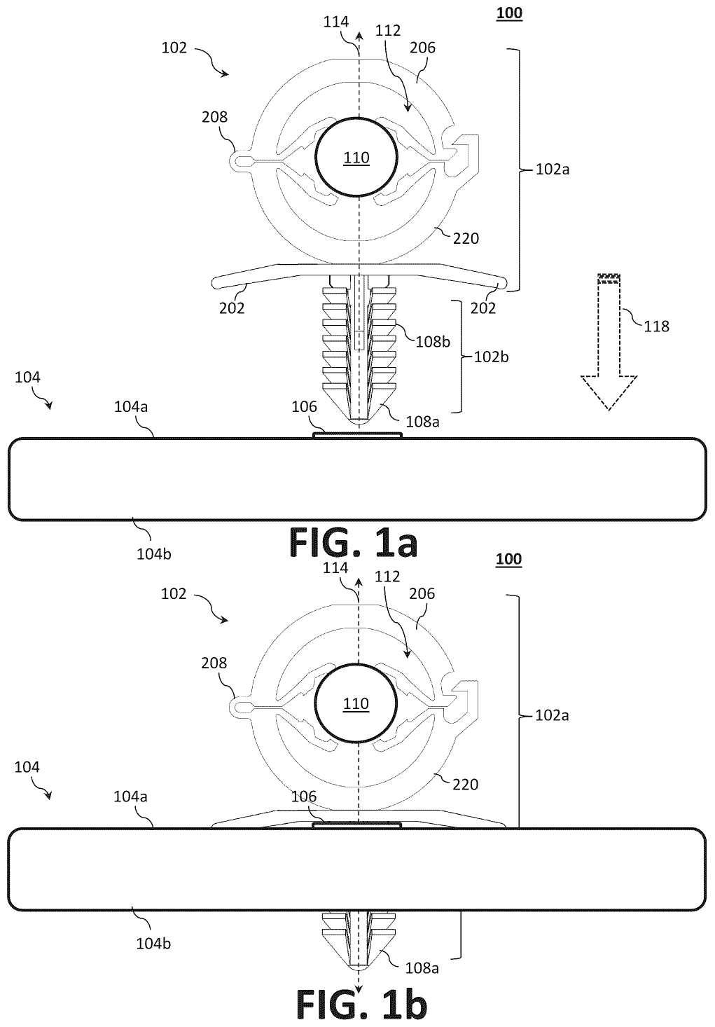

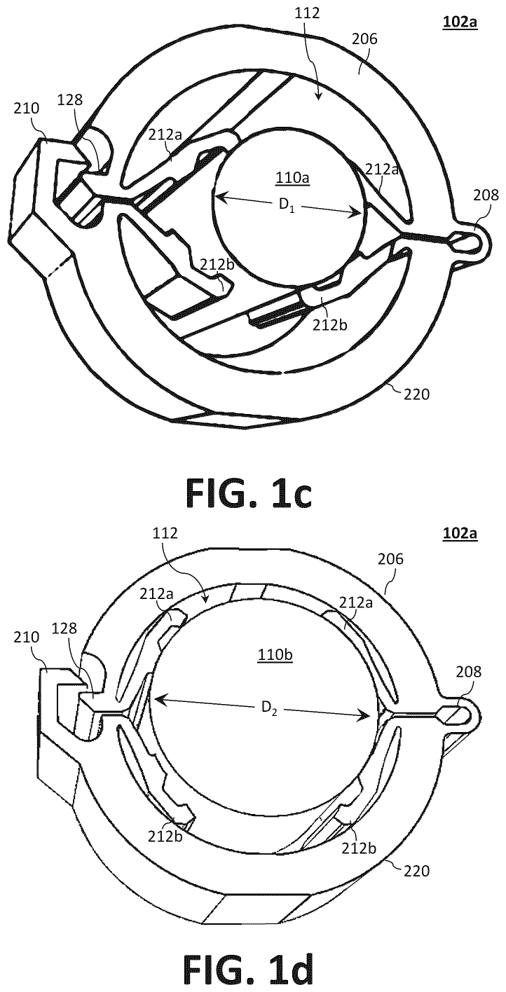

FIGS. 1a and 1b illustrate a fastening system 100 designed to secure a tube 110 relative to a component 104 with an opening 106, utilizing a tube retainer 102, in accordance with an aspect of this disclosure. The tube 110 may be, for example, one or more of brake lines, fuel lines, wires, cables (e.g., electric cables), pipes, or any other tubular structure that may be secured to a component 104. In the illustrated example, the tube retainer 102 is configured to retain tubes 110 of different diameters. FIGS. 1c and 1d illustrate first and second isometric views of the tube retainer 102 from FIGS. 1a and 1b, showing it securing a first tube with a diameter (D₁) and a second tube with a different diameter (D₂), respectively. While the tube retainer 102 will be described primarily as a tube retainer configured to attach a tube 110, it can be used to attach other objects and components.

The tube retainer 102 may include, define, or otherwise provide a retainer portion 102a and a fastener portion 102b. The illustrated fastener portion 102b is generally perpendicular to the retainer portion 102a, such that a central longitudinal axis 114 running down the center of the fastener portion 102b is generally perpendicular to a lateral axis 120 running along the retainer portion 102a. In other examples, the central longitudinal axis 114 running down the center of the fastener portion 102b is positioned at other angles transverse to the lateral axis 120. The fastener portion 102b can be integrated with the retainer portion 102a or attached during assembly (e.g., via adhesives, welding, a mechanical coupling, or the like). In the illustrated example, a pair of wings 202 are positioned at or near a junction between the retainer portion 102a and the fastener portion 102b to mitigate wobble and/or buzz, squeak, and rattle (BSR), which can be caused by unintended contact or vibration between the tube retainer 102 and the component 104. In some examples, the fastener portion 102b is omitted where attachment to a component 104 isn't needed.

The component 104 defines an A-side surface 104a (e.g., a first surface, such as an exterior surface) and a B-side surface 104b (e.g., a second surface, such as an interior surface). The tube 110 is illustrated as being secured to or on the A-side surface 104a. The component 104 may be, for example, an automotive panel, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like. Depending on the application, the component 104 may be fabricated from metal (or a metal alloy), synthetic or semi-synthetic polymers (e.g., plastics, such as acrylonitrile butadiene styrene (ABS) and polyvinyl chloride (PVC), etc.), composite materials (e.g., fiberglass), or a combination thereof.

The component 104 may include, define, or otherwise provide the opening 106, which may be formed during manufacturing of the component 104 or attached during assembly. During installation, the fastener portion 102b of the tube retainer 102 is inserted into the opening 106 formed in or on a surface of the component 104, as indicated by arrow 118, such that the panel-retention features engage the opening 106 (e.g., the perimeter of the component 104 that defines the opening). In some examples, the tube retainer 102 may comprise a seal to mitigate dust, dirt, and/or moisture penetration through the opening 106. The seal may be embodied as a ring (e.g., an annulus) and fabricated from foam material, thermoplastic, rubber, etc. For example, a seal can be configured to fit over the distal end of the tube retainer 102 to surround a portion of the fastener portion 102b (e.g., the shank).

The retainer portion 102a is configured to couple with and/or secure one or more objects (illustrated as tubes 110) relative to one another and, ultimately, to the component 104. The retainer portion 102a is illustrated with a pocket 112 configured to secure a tube 110.

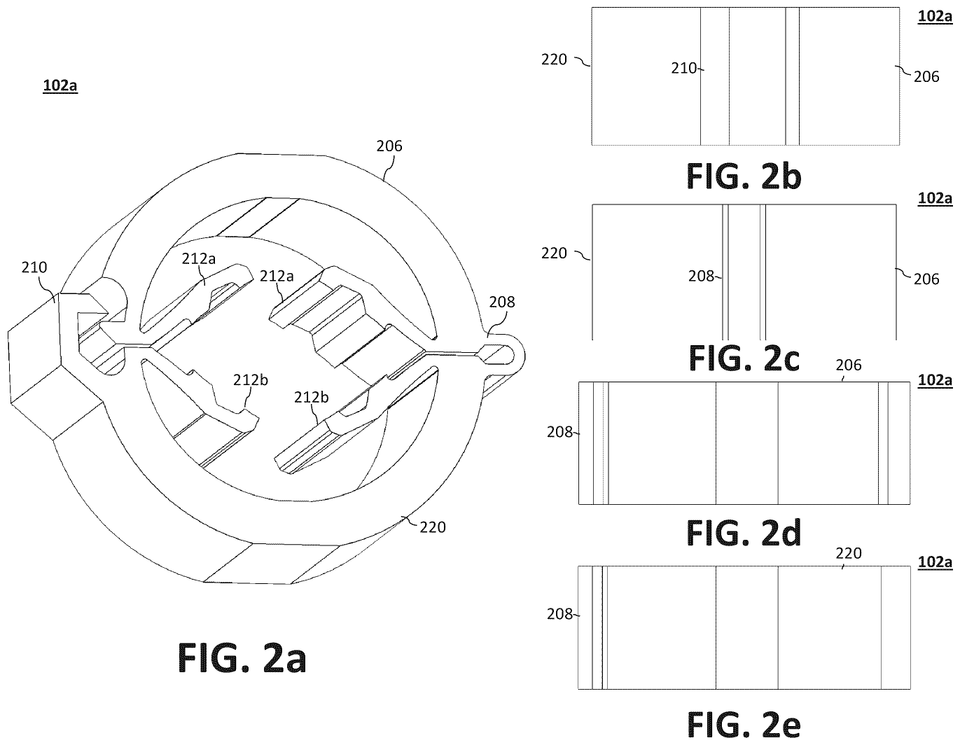

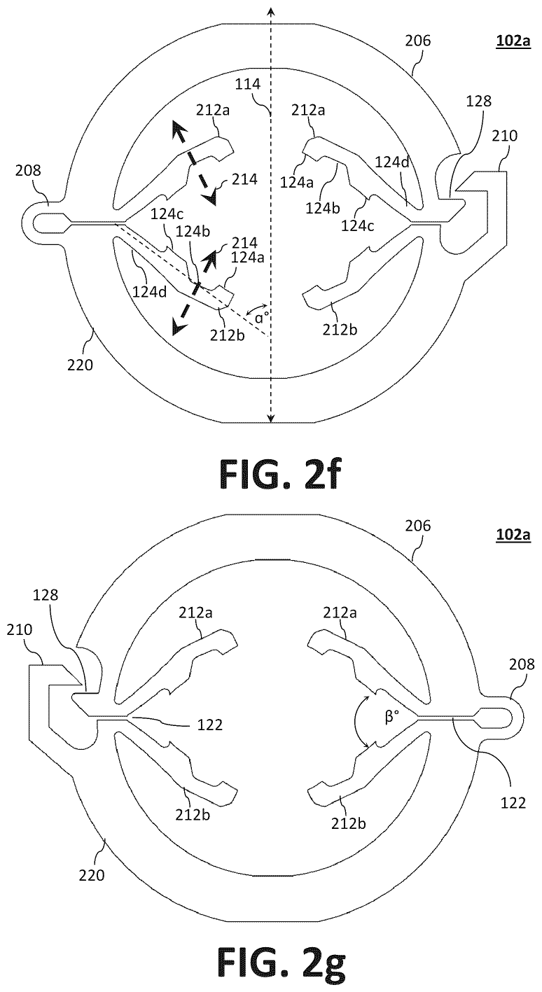

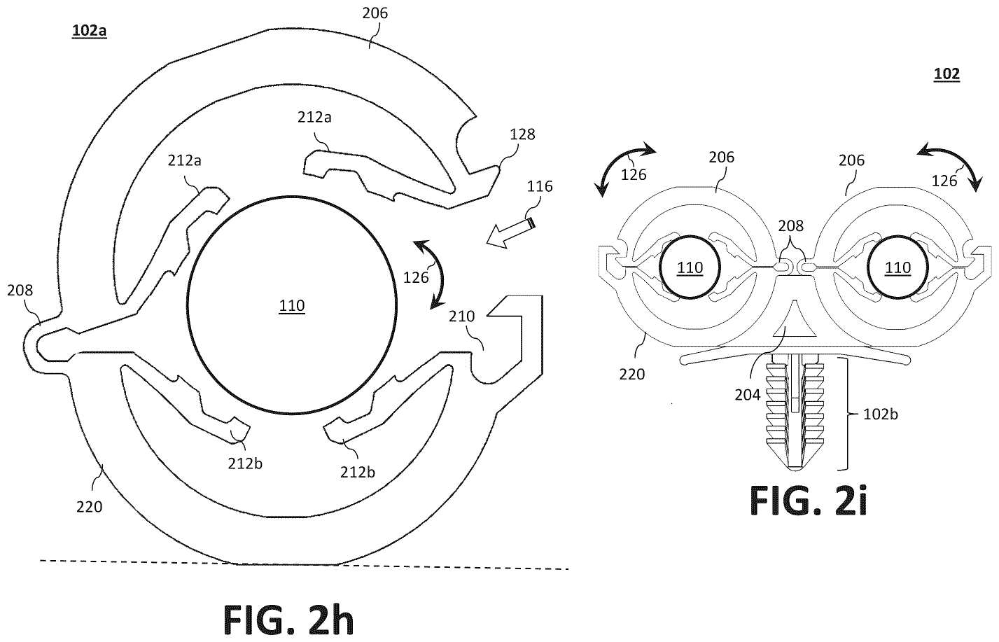

FIG. 2a illustrates an isometric view of the retainer portion 102a of the tube retainer 102, as shown in FIGS. 1a through 1d, in the closed position. FIGS. 2b and 2c show elevation views of the first and second sides of the retainer portion 102a, respectively. FIGS. 2d and 2e illustrate top and bottom plan views of the retainer portion 102a. FIGS. 2f and 2g illustrate elevation views of the front and rear sides of the retainer portion 102a. FIG. 2h shows an elevation view of the front side of the retainer portion 102a in the open position. Finally, FIG. 2i illustrates a tube retainer 102 in accordance with an aspect of this disclosure configured to secure multiple tubes 110.

The retainer portion 102a includes a lid 206 to secure the tube 110 within a pocket 112. The lid 206 can pivot about a hinge 208 between an open position (e.g., as illustrated in FIG. 2h) and the closed position (e.g., as illustrated in FIGS. 2f and 2g) as indicated by arrow 126 to provide access to a pocket 112 during installation of the tube 110 (or other objects). When in the open position, the tube 110 can be inserted into the pocket 112 by urging the tube 110 toward the respective pocket 112 in the direction indicated by arrow 116. Once the tube 110 is inserted, the lid 206 can be pivoted about the hinge 208 to the closed position. A snap 128 is provided at the free end of the lid 206 (e.g., opposite the hinge 208) that is configured to engage a corresponding feature 210 formed in or on the body 220 of the retainer portion 102a, such as a recess, opening, or otherwise having a ledge, edge, or other protrusion. In some examples, the snap 128 may include a button or tab that a user can manipulate to release the snap 128 from its corresponding feature 210 to open the lid 206 and remove a tube 110. In such example, the button or tab can be configure to disengage the snap 128 from its a corresponding feature 210 to open the lid 206.

In lieu of the lid 206, a pocket 112 may be shaped to secure the tube 110 via an interference fit (e.g., via features positioned at the opening to the plurality of pockets 112, such as a ledge, bumps, etc.). While a single pocket 112 is illustrated, additional pockets 112 may be provided depending on the design needs (e.g., the number of tubes 110 that need to be secured), an example of which is illustrated in FIG. 2i, which is configured to secure 2 tubes 110. The width of the retainer portion 102a can be adjusted accordingly to accommodate the desired number of pockets 112 and/or tubes 110.

Each of the plurality of pockets 112 can be shaped as a channel or passageway (when in a closed position, as best illustrated in FIGS. 2f and 2g) sized to accept the outer diameter of the tubes 110. In some examples, each of the plurality of pockets 112 can be shaped as a channel or passageway with a cross-sectional profile that is circular, oval, quadrilateral, etc. The plurality of pockets 112 provides an inner diameter or width that generally corresponds to the outer size and/or shape of the tubes 110.

With reference to FIGS. 2f and 2g, the pocket 112 includes two sets of flexible fingers 212a, 212b, designated as a first set of flexible fingers 212a and a second set of flexible fingers 212b. As illustrated, the first set of flexible fingers 212a are resiliently coupled to the lid 206, while the second set of flexible fingers 212b are coupled to the body 220. In this example, each of the

In the illustrated examples, each of the flexible fingers 212a, 212b is resiliently coupled to the lid 206 or the body 220 at or near the closure area 122 between the lid 206 and the body 220. In other words, the flexible fingers 212a, 212b extend laterally inward (e.g., from the sides) toward the central longitudinal axis 114 at an angle (α°) relative to the central longitudinal axis 114. The angle (α°) may be, for example, about 30 to 60 degrees, about 40 to 50 degrees, or about 45 degrees.

The flexible fingers 212a, 212b are designed to interfere with the tube's 110 surface, yielding a secure hold. The flexible fingers 212a, 212b are made of a flexible material that can be tuned during manufacturing to accommodate a ranges diameters for tube 110. To enhance the surface area contact with the tube 110, each of the illustrated first and second sets of flexible fingers 212a, 212b includes an arm portion 124d that is resiliently coupled to the retainer portion 102a (e.g., the lid 206 and/or body 220).

In operation, when a tube 110 is inserted into the retainer portion 102a, the flexible fingers 212a, 212b bend to accommodate the tube's diameter. For example, the flexible fingers 212a, 212b can flex at a proximal end, such as where they connect to the retainer portion 102a of the arm portion 124d. Portions of the flexible fingers 212a, 212b may be fabricated with less material (e.g., smaller in diameter or size) to increase flexibility. This adjustability provides versatility, allowing the fastener to be used with different tube sizes without compromising retention force. The flexible fingers 212a, 212b apply force from multiple directions, ensuring a firm grip on the tube. This interference increases resistance to sliding forces, preventing the tube from moving longitudinally within the retainer portion 102a.

To increase contact with the tube 110, each of the first set of flexible fingers 212a and the second set of flexible fingers 212b may include an arm portion 124d having, on its interior side (i.e., the side facing the tube 110), a first engagement feature 124a and a second engagement feature 124c, spaced apart by a valley 124b. The first engagement feature 124a and the second engagement feature 124c are illustrated as multi-faceted features designed to contact the exterior surface of the tube. The first engagement feature 124a is better suited for engaging a tube with a larger diameter (D2), while the second engagement feature 124c is more effective for engaging a tube with a smaller diameter (D1).

The first and second engagement features, 124a and 124c, are designed as multi-faceted structures, each configured to make contact with the exterior surface of the tube 110. The multi-faceted design of these engagement features 212a, 212c increases the gripping effectiveness by creating multiple contact points with the tube, thereby distributing the gripping force more evenly. This configuration allows the fingers to apply force to the tube from multiple directions, ensuring a firm grip regardless of the tube's diameter. The design enhances the fastener's ability to resist sliding forces, making it a reliable solution for various applications.

The first engagement feature 124a and the second engagement feature 124c are positioned so that one feature is optimized for engaging a tube with a larger diameter (D2), while the other is more effective for a tube with a smaller diameter (D1). This design allows the flexible fingers 212a, 212b to securely accommodate tubes of varying diameters, ensuring a robust hold regardless of the tube's size. Additionally, the valley 124b between the engagement features serves as a flexible hinge, allowing the arm portion 124d to adapt its shape and maintain consistent pressure against the tube 110, further enhancing the system's retention capabilities.

The first set of flexible fingers 212a, illustrated as an upper set, is formed on the interior surface of the lid 206. The second set of flexible fingers 212b, illustrated as a lower set, is formed on the interior surface of the pockets 112 created by the retainer portion 102a. For example, each of the two sets of flexible fingers 212a, 212b can be connected to the retainer portion 102a and to each other at their respective proximal ends, while the distal, free ends flare outwardly to define a cavity that receives or partially surrounds the tube 110. The inner surfaces of the flexible fingers 212a, 212b may include retention features such as ridges or grooves to increase friction and prevent slippage. In the illustrated example, each of the first set of flexible fingers 212a is adjacent to a corresponding one of the second set of flexible fingers 212b, where adjacent flexible fingers form an angle (β°) relative to one another. The angle (β°) may be, for example, about 60 to 120 degrees, about 80 to 100 degrees, or about 90 degrees.

The flexible fingers 212a, 212b are configured to flex inward and outward, as indicated by arrows 214 in FIG. 24, allowing them to accommodate tubes 110 of different diameters. When a tube is inserted, the flexible fingers 212a, 212b flex outward to receive the tube and then snap back into place, ensuring a firm grip. The flexible fingers are designed to interfere with each other or with the sides of the lid 206 and body 220, creating a cam-like force on the tube retainer. This interference generates a force on the tube, increasing resistance to sliding and ensuring a secure hold.

In other words, the flexibility of the retainers allows the second set of flexible fingers 212b to interfere (e.g., abut or make contact) with the lid at a first location 216 when a large tube 110 is installed, and at a second location 218 when a small tube is installed. The first location 216 is positioned on the main body of the lid, while the second location 218 is at the free ends of the first set of flexible fingers 212a. The dimensions of the flexible fingers 212a, 212b can be tailored to match the specific outer diameter of the tube, ensuring a secure fit regardless of the tube size.

The fastener portion 102b of the illustrated tube retainer 102 serves to couple the retainer portion 102a to the component 104. As illustrated, the fastener portion 102b is generally perpendicular to the retainer portion 102a such that a central longitudinal axis 114 runs down the center of the fastener portion 102b. The fastener portion 102b is illustrated as a push-pin assembly (sometimes called trees, pine trees, Christmas trees, etc.) that comprises a plurality of fins 108b distributed or otherwise arranged along the length of the fastener body 108a of the fastener portion 102b. The leading end of the fastener portion 102b (e.g., the tip of the fastener body 108a) can be rounded, tapered, or otherwise shaped to increase ease of insertion into the opening 106 by helping to align and guide the fastener portion 102b into the opening 106.

The fins 108b may be shaped as blades, teeth, barbs, or the like. As illustrated, the fins 108b are angled away from the central longitudinal axis 114 and are configured to deflect inward toward the central longitudinal axis 114 as the fastener portion 102b is passed through the opening 106 in the component 104. The fins 108b are angled upwardly relative to the central longitudinal axis 114 (forming an acute angle between each fin 108b and the central longitudinal axis 114) to resist pullout forces. To form the connection with the component 104, the fastener portion 102b of the tube retainer 102 is inserted into an opening 106 formed in or on a surface of the component 104 as indicated by the arrow 118. In some examples, the fastener portion 102b can extend beyond the component 104 to exit and protrude from the B-side surface 104b as best illustrated in FIG. 1b.

The tube retainer 102 may be formed as a unitary structure. In one example, the tube retainer 102 can be fabricated via mold tooling and a plastic-injection molding process. In another example, the tube retainer 102 can be a printed thermoplastic material component that can be printed with great accuracy and with numerous details, which is particularly advantageous, for example, in creating components requiring complex and/or precise features. In addition, additive manufacturing techniques obviate the need for mold tooling typically associated with plastic injection molding, thereby lowering up-front manufacturing costs, which is particularly advantageous in low-volume productions. In some examples, the tube retainer 102 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process.

Additive manufacturing techniques print objects in three dimensions, therefore both the minimum feature size (i.e., resolution) of the X-Y plane (horizontal resolution) and the layer height in Z-axis (vertical resolution) are considered in overall printer resolution. Horizontal resolution is the smallest movement the printer's extruder can make within a layer on the X and the Y axis, while vertical resolution is the minimal thickness of a layer that the printer produces in one pass. Printer resolution describes layer thickness and X-Y resolution in dots per inch (DPI) or micrometers (μm). The particles (3D dots) in the horizontal resolution can be around 50 to 100 μm (510 to 250 DPI) in diameter. Typical layer thickness (vertical resolution) is around 100 μm (250 DPI), although the layers may be as thin as 16 μm (1,600 DPI). The smaller the particles, the higher the horizontal resolution (i.e., higher the details the printer produces). Similarly, the smaller the layer thickness in Z-axis, the higher the vertical resolution (i.e., the smoother the printed surface will be). A printing process in a higher vertical resolution printing, however, will take longer to produce finer layers as the printer has to produce more layers. In some examples, the tube retainer 102 may be formed or otherwise fabricated at different resolutions during a printing operation. For example, the retainer portion 102a (or portions thereof) may be printed at a lower resolution than that of the fastener portion 102b or vice versa as needed for a particular application.

While it is contemplated that all portions of the tube retainer 102 would be formed during the same printing session (i.e., printed during the same printing operation), it is possible that the tube retainer 102 may be printed in two sessions. For example, the retainer portion 102a may be printed with one or more landmark structures (e.g., a protrusion or a recess) during a first session that can be located and filled and/or surrounded with material during a second session to form the fastener portion 102b.

In some examples, the tube retainer 102 comprises one or more windows 204 (e.g., recesses, cut outs, or openings) formed in or on a body 220 of the retainer portion 102a and/or the fastener portion 102b. The one or more windows 204 can serve to reduce the amount of material needed to fabricate the tube retainer 102, thus reducing material cost and part weight. The leading end can be rounded, tapered, or otherwise shaped to increase insertion ease of the opening 106.

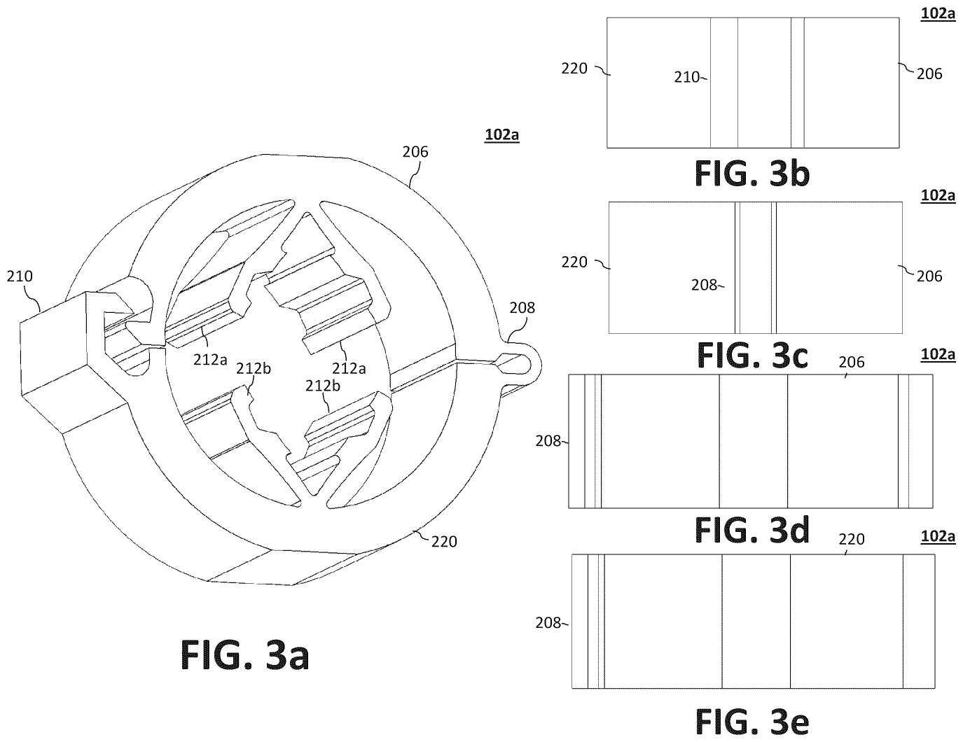

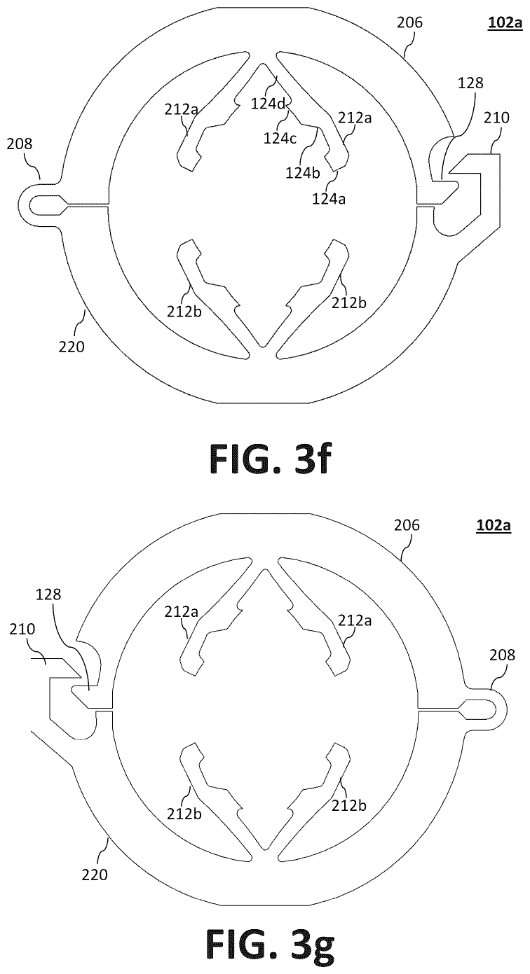

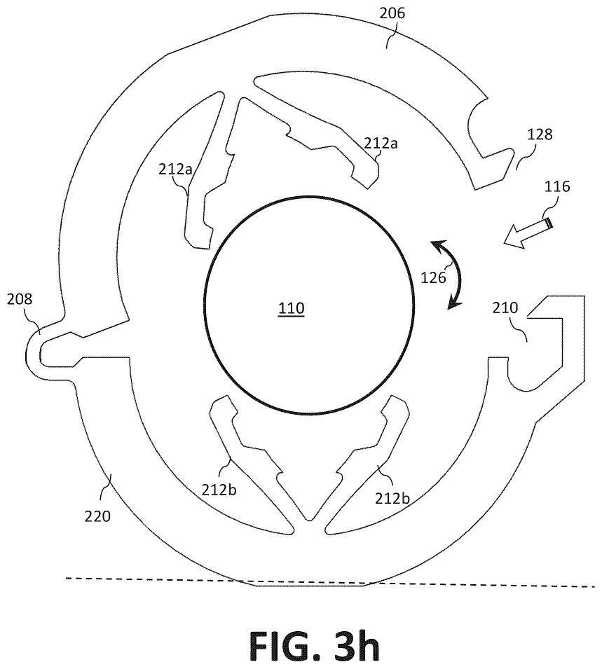

FIG. 3a illustrates an isometric view of the retainer portion 102a for the tube retainer 102 in the closed position, according to another example. FIGS. 3b and 3c display elevation views of the first and second sides of the retainer portion 102a, respectively. FIGS. 3d and 3e illustrate top and bottom plan views of the retainer portion 102a. FIGS. 3f and 3g illustrate elevation views of the front and rear sides of the retainer portion 102a. Finally, FIG. 3h illustrates an elevation view of the front side of the retainer portion 102a in the open position.

The retainer portion 102a of FIGS. 3a through 3h is substantially the same as the retainer portion 102a of FIGS. 2a through 2i, except for the placement of the first set of flexible fingers 212a and the second set of flexible fingers 212b. In the illustrated examples, each of the first set of flexible fingers 212a is resiliently coupled to an interior surface of the lid 206 at or near its apex, while each of the second set of flexible fingers 212b is resiliently coupled to an interior surface of the body 220 at or near its bottom-most region. In other words, the flexible fingers 212a, 212b extend vertically upward and downward (e.g., from the top and bottom) toward one another. In the illustrated example, each of the first set of flexible fingers 212a and each of the second set of flexible fingers 212b is positioned to form an angle (β°) relative to one another. The angle (β°) may be, for example, about 60 to 120 degrees, about 70 to 110 degrees, or about 80 degrees.

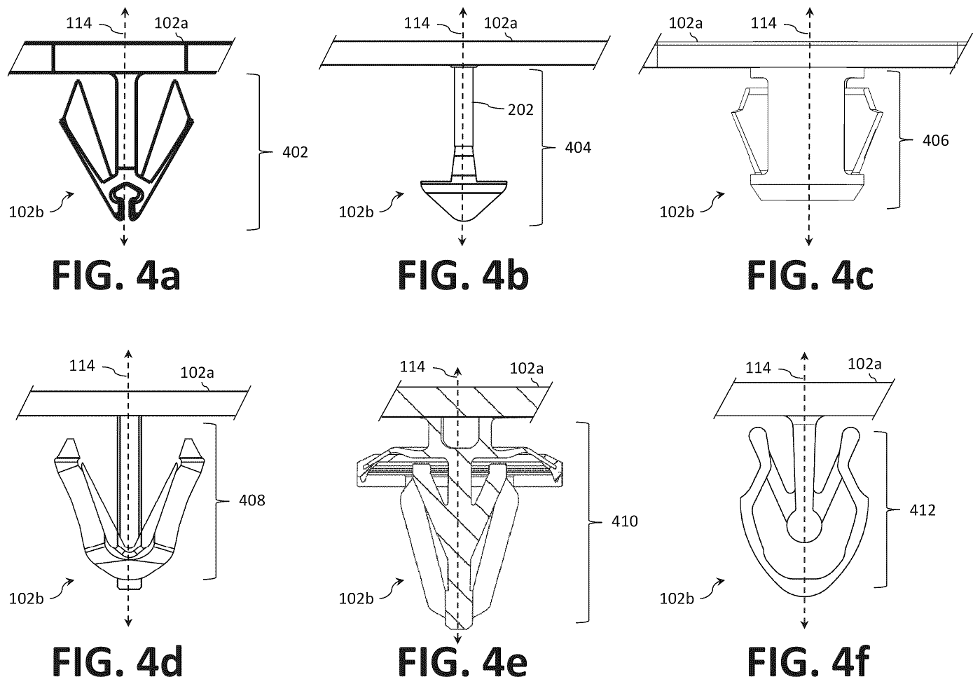

While the fastener portion 102b is illustrated in the figures as a push-pin fastener, other fastener designs are contemplated. For example, FIGS. 4a through 4f illustrate additional fastener styles that can be used as the fastener portions 102b suitable for coupling the retainer portion 102a with the component 104. Specifically, FIGS. 4a through 4f illustrate, respectively, a W-shaped clip fastener 402 (illustrated as a 2-legged clip fastener), pin fastener 404, a box-prong fastener 406 (illustrated as a 2-legged box-prong fastener), a specialty clip assembly 408 (e.g., a CenterLok™ fastener, which is available from Deltar®), a clip assembly with four retaining legs 410, and an clip assembly with two snap-engaging seats 412. The clip assembly with four retaining legs 410, which is illustrated in FIG. 4e as a cross-sectional view, is further described in connection with commonly owned U.S. Pat. No. 10,385,901 to Jeffrey J. Steltz. The clip assembly with two snap-engaging seats 412 of FIG. 4f is further described in connection with commonly owned U.S. Pat. No. 10,018,214 to Fulvio Pacifico Yon.

The above-cited patents and patent publications are hereby incorporated by reference in their entirety. Where a definition or the usage of a term in a reference that is incorporated by reference herein is inconsistent or contrary to the definition or understanding of that term as provided herein, the meaning of the term provided herein governs and the definition of that term in the reference does not necessarily apply.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A tube retainer for retaining tubes of various diameters, the tube retainer comprising:
a body configured to receive a tube via a tube pocket;
a lid coupled to the body via a hinge; and
a plurality of flexible fingers extending into the tube pocket and configured to flex to accommodate a diameter of the tube,
wherein the plurality of flexible fingers comprises a first set of flexible fingers resiliently coupled to the lid and a second set of flexible fingers resiliently coupled to the body.

2. The tube retainer of claim 1, wherein each of the plurality of flexible fingers extends inward toward a central longitudinal axis.

3. The tube retainer of claim 1, wherein each of the first set of flexible fingers extends from the lid toward the base and each of the second set of flexible fingers extends from the base toward the lid.

4. The tube retainer of claim 1, wherein the first set of flexible fingers are arranged to form an angle relative to one another that is between 70 and 110 degrees and the second set of flexible fingers are arranged to form an angle relative to one another that is between 70 and 110 degrees.

5. The tube retainer of claim 1, wherein each of the plurality of flexible fingers comprises a first engagement feature and a second engagement feature spaced apart from the first engagement feature.

6. The tube retainer of claim 1, further comprises a snap at an end of the lid opposite the hinge that is configured to engage a corresponding feature formed in or on the body.

7. The tube retainer of claim 1, wherein the tube retainer is configured to secure the tube relative to a component via a fastener defining a central longitudinal axis, wherein the fastener is configured to engage the component via an opening.

8. The tube retainer of claim 1, wherein the lid comprises a snap configured to engage a corresponding feature formed in or on the body, and wherein the snap comprises a button configured to disengage the snap from the corresponding feature.

9. The tube retainer of claim 1, wherein the body, the lid, and the hinge are fabricated as a unitary structure.

10. The tube retainer of claim 1, wherein the body, the lid, the hinge, and the plurality of flexible fingers are fabricated as a unitary structure.

11. The tube retainer of claim 1, wherein each of the first set of flexible fingers and the second set of flexible fingers are configured to flex towards and away from one another to accommodate the tube.

12. A tube retainer for securing tubes of various diameters relative to a component, the tube retainer comprising:
a body configured to receive a tube via a tube pocket;
a lid coupled to the body via a hinge;
a plurality of flexible fingers extending into the tube pocket and configured to flex to accommodate a diameter of the tube,
wherein the plurality of flexible fingers comprises a first set of flexible fingers resiliently coupled to the lid and a second set of flexible fingers resiliently coupled to the body; and
a fastener coupled to the body and defining a central longitudinal axis,
wherein the tube retainer is configured to secure the tube relative to a component via the fastener and an opening formed in the component.

13. The tube retainer of claim 12, wherein each of the plurality of flexible fingers extends inward toward a central longitudinal axis.

14. The tube retainer of claim 12, wherein each of the first set of flexible fingers extends from the lid toward the base and each of the second set of flexible fingers extends from the base toward the lid.

15. The tube retainer of claim 12, wherein the first set of flexible fingers are arranged to form an angle relative to one another that is between 70 and 110 degrees and the second set of flexible fingers are arranged to form an angle relative to one another that is between 70 and 110 degrees.

16. The tube retainer of claim 12, wherein each of the plurality of flexible fingers comprises a first engagement feature and a second engagement feature spaced apart from the first engagement feature.

17. The tube retainer of claim 12, further comprises a snap at an end of the lid opposite the hinge that is configured to engage a corresponding feature formed in or on the body.

18. The tube retainer of claim 12, wherein the lid comprises a snap configured to engage a corresponding feature formed in or on the body, and wherein the snap comprises a button configured to disengage the snap from the corresponding feature.

19. The tube retainer of claim 12, wherein the body, the lid, the hinge, and the plurality of flexible fingers are fabricated as a unitary structure.

20. The tube retainer of claim 12, wherein each of the first set of flexible fingers and the second set of flexible fingers are configured to flex towards and away from one another to accommodate the tube.
